(19) United States
(12) Patent Application Publication
(10) Pub. No.: US 2026/0326180 A1
(43) Pub. Date: Oct. 22, 2026

(54) VISUALIZATION SYSTEMS AND METHODS FOR HARSH PRODUCTION ENVIRONMENTS DURING METAL PROCESSING

(71) Applicant: Novelis Inc., Atlanta, GA (US)

(72) Inventors: Robert Armbrust de Freitas QUINTAL, Woodstock, GA (US); Felipe MAPPA FRANCA ROCHA, Acworth, GA (US)

(73) Assignee: Novelis Inc., Atlanta, GA (US)

(21) Appl. No.: 19/104,132

(22) PCT Filed: Aug. 14, 2023
(86) PCT No.: PCT/US2023/030179

§ 371 Date: Feb. 14, 2025

Related U.S. Application Data
(60) Provisional application No. 63/371,795, filed on Aug. 18, 2022.

(51) Int. Cl. B21B 38/00; B21B 37/00; H04N 23/20

(52) U.S. Cl. CPC B21B 38/00; B21B 37/00; H04N 23/20

(57) ABSTRACT

A metal processing system for a metal substrate includes a vision system for providing visual data about the metal substrate in a harsh environment. The harsh environment may at least partially conceal the metal substrate in the visible spectrum due to the generation of fumes, mist and the like during metal processing.

### REFERENCE TO RELATED APPLICATION

This application claims the benefit of U.S. Provisional Patent Application No. 63/371,795, filed on Aug. 18, 2022, and entitled VISUALIZATION SYSTEMS AND METHODS FOR HARSH PRODUCTION ENVIRONMENTS DURING METAL PROCESSING, the content of which is hereby incorporated by reference in its entirety.

### FIELD OF THE INVENTION

This application relates to metal processing of metals such as but not limited to aluminum and aluminum alloys. More particularly, the application relates to systems and methods for metal strip visualization in harsh production environments during metal processing.

### BACKGROUND

A metal processing system for metal substrates may include a number of locations in which a harsh environment is generated due to the processes being performed. Such harsh environments limit visualization by operators of the metal substrate and/or the processes being performed on the metal substrate, and the limited visualization may allow problems to occur in the metal substrate and/or the processes because they are not seen. As an example, a rolling mill provides a harsh environment in which dense fumes are generated that make visualization of the rolling process very limited, if at all possible. Such limited visibility may allow problems to occur such as but not limited to flatness issues during threading and/or surface quality issues.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a metal processing system includes a vision system for a harsh environment that conceals, in a visible spectrum, at least a portion of a metal substrate. The vision system includes at least one camera for detecting the metal substrate in the harsh environment and providing visual data of the metal substrate in the harsh environment.

According to some embodiments, a metal processing system includes a work station for processing a metal substrate and that generates a harsh environment during metal processing. The harsh environment may include a fume or mist at least partially concealing the metal substrate at the work station. The metal processing system also includes a vision system having at least one camera for detecting the metal substrate in the harsh environment at the work station and providing visual data of the metal substrate in the harsh environment at the work station.

According to various embodiments, a method of processing a metal substrate with a metal processing system includes moving the metal substrate in a harsh environment that conceals, in the visible spectrum, at least a portion of the metal substrate. The method also includes detecting the metal substrate in the harsh environment using at least one camera of a vision system, and providing visual data of the metal substrate in the harsh environment using the at least one camera.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 is a side view of a metal processing system with a visualization system according to embodiments.

FIG. 2 is an end view of another metal processing system with a visualization system according to embodiments.

FIG. 3A is a photograph of a location of a portion of a metal processing system using a visible spectrum camera.

FIG. 3B is a photograph of the location of FIG. 3A using a visualization system according to embodiments.

FIG. 3C is a photograph of the location of FIG. 3A using another visualization system according to embodiments.

FIG. 4 is a photograph of a portion of a metal processing system using a visualization system according to embodiments.

FIG. 5 is a photograph of a portion of a metal processing system using a visualization system according to embodiments.

FIG. 6 is a photograph of a portion of a metal processing system using a visualization system according to embodiments.

### DETAILED DESCRIPTION

Described herein are visualization systems and methods for harsh environments during metal processing. In certain embodiments, the visualization systems and methods described herein may be useful for metal processing of aluminum and aluminum alloys, although in other embodiments any type of metal substrate may be processed. The visualization systems and methods described herein allow for visualization of areas of a metal processing system that otherwise are concealed or hidden in the visible spectrum (e.g., due to fumes, mist, etc.). In certain embodiments, visualization systems include one or more infrared cameras. The infrared cameras may be configured to detect different spectrum ranges from near infrared (NIR) to long-wave infrared (LWIR), and in certain embodiments at least one camera optionally is a LWIR camera or a short-wave infrared (SWIR) camera. Visual data from the one or more infrared cameras may be provided to operators of the metal processing system to provide improved visualization of the processes being performed compared to traditional techniques. The systems and methods described herein may also facilitate detection of problem or issues with the metal substrate and/or equipment that is otherwise hidden in the visible spectrum during metal processing. In some embodiments, the visual data from the visualization systems may be used by a control system to generate one or more control responses such as but not limited to generating alerts, performing analysis, and/or controlling equipment. Various other benefits and advantages may be realized with the systems and methods provided herein, and the aforementioned advantages should not be considered limiting.

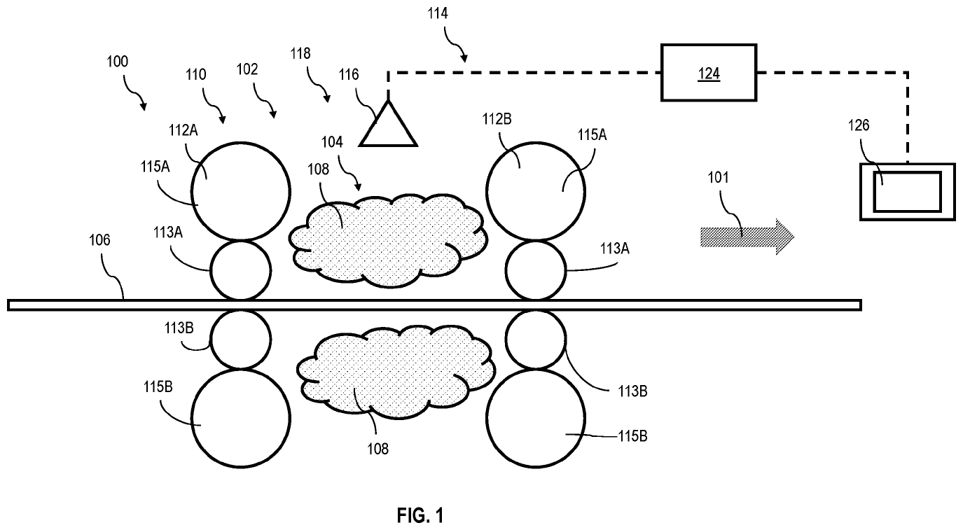

FIG. 1 illustrates a metal processing system 100 with a work station 102 producing a harsh environment 104 during processing of a metal substrate 106 (processing movement represented by arrow 101). As used herein, a harsh environment is one in which portions of the work station 102 and/or the metal substrate 106 are concealed and/or otherwise not observable on the visible spectrum due to dense fumes 108, mist, water on the metal, oil on the metal, and/or other environmental conditions caused by the metal processing using the work station 102 on the metal and/or the surrounding environment.

In the embodiment illustrated in FIG. 1, the work station 102 is a rolling mill 110 having work stands 112A-B for rolling the metal substrate 106. Each work stand 112A-B includes work rolls 113A-B and backup rolls 115A-B. In other embodiments, the work station 102 may be rolling mills with other configurations as desired, and/or the work station 102 may be other equipment and/or locations of the metal processing system 100 such as but not limited to a casting pit for an ingot, an ingot preparation area inside a preheat furnace, a scrap bin, and/or other process stations and/or combinations of process stations as desired.

According to various embodiments, the metal processing system 100 includes a visualization system 114 for generating visual data of the work station 102 and/or the metal substrate 106 in the harsh environment 104. The visualization system 114 includes at least one camera 116, and in certain embodiments, the visualization system 114 may include a plurality of cameras. In various embodiments, the one or more cameras 116 are infrared (or thermal) cameras that create an image or visual data using infrared radiation. The visualization system 114 with infrared cameras as the one or more cameras 116 allows for visualization of the metal substrate 106 and/or the equipment of the work station 102 through the dense fume 108 and/or other environmental conditions of the harsh environment 104 (e.g., water on the metal, oil on the metal, etc.). The infrared cameras may detect different ranges of infrared radiation such as but not limited to NIR, SWIR, midwave infrared (MWIR), and/or LWIR. In one non-limiting example, the camera 116 is a LWIR camera. When a plurality of cameras 116 are included, the cameras 116 may be a same type of infrared camera or different types of infrared cameras as desired. Optionally, the one or more thermal cameras 116 may include various filters to further modify the visual data using infrared radiation.

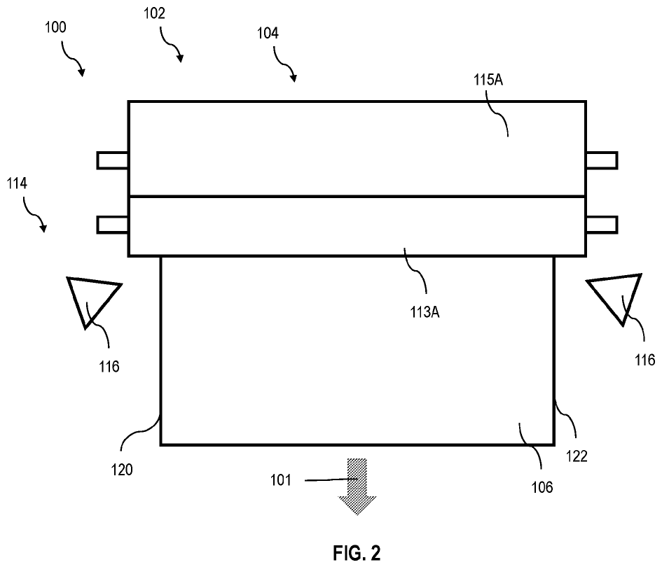

The one or more cameras 116 may be provided at various locations relative to equipment of the work station 102 and/or relative to the metal substrate 106 as desired. As a non-limiting example, in FIG. 1, the camera 116 is provided at an inter-stand location 118 and above the metal substrate 106. FIG. 2 illustrates an example of another metal processing system 100, and compared to FIG. 1, FIG. 2 illustrates the visualization system 114 with two cameras 116. In FIG. 2, the cameras 116 are provided offset from edges 120, 122 of the metal substrate 106. In other embodiments, other numbers and/or locations of cameras 116 may be utilized as desired.

Optionally, the visualization system 114 includes one or more controllers 124 (processing unit and/or memory device) communicatively coupled to the one or more cameras 116 using various communication techniques as desired. The processing unit of the controller may be various suitable processing devices or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the controller 124 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium”, “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the controller 124 optionally includes an associated user interface 126, including but not limited to a human machine user interface, such that the controller 124 may obtain information from a user and/or provide information to the user via the user interface 126. When included, the user interface 126 may be on the controller 124 itself or may be at a location remote from the controller 124 such as, but not limited to, another location within the metal processing system 100. Additionally or alternatively, the controller 124 optionally may include various communication modules such that the controller 124 may receive and/or send information to a user device and/or other location as desired. Non-limiting examples of communication modules may include systems and mechanisms enabling wired communication and/or wireless communication (e.g., Industrial Ethernet, Profibus®, near field, cellular, Wi-Fi, Bluetooth®, Bluetooth Low Energy (BLE), GigE Vision® interface, short form-factor pluggable plus (SFP+), CoaXPress (CXP), Camera Link (CL), USB3 Vision (Universal Serial Bus 3), embedded vision applications, etc.).

The controller 124 of the visualization system 114 is communicatively coupled to the one or more cameras 116 such that the controller 124 receives the visual data from the cameras 116. The controller 124 may generate various control or output responses based on the visual data from the cameras 116. In some embodiments, the output response may include providing the visual image of the work station 102 and/or metal substrate 106 in the harsh environment 104 to an operator (e.g., via the user interface 126, via another interface, via a user device, etc.), thereby allowing the operator to view the equipment and/or metal substrate 106. Additionally or alternatively, the control response may include generating an alert or notification on the user interface 126 and/or other interface based on the visual data, and/or the control response may include controlling equipment of the work station 102 and/or the metal processing system 100.

In some embodiments, the control response generated by the controller 124 may be based on various analysis of the visual data from the one or more cameras 116. As non-limiting examples, the controller 124 may generate control responses based on a detection of a flatness issues in the visual data, based on a detection of edges of the metal substrate in the visual data, based on a strip centralization measurement in the visual data, based on a detection of a defect in the metal substrate using the visual data, based on substrate temperature gradients using the visual data, based on detected roll thermal camber using the visual data, combinations thereof, and/or other analysis as desired. Various other analysis may be performed by the controller 124 as desired, and the aforementioned examples should not be considered limiting.

The output response from the controller 124 may provide improved visualization of the harsh environment 104 to the operator of the metal processing system 100, which in turn may allow for improved control of the metal substrate 106 and/or the work station 102 during metal processing. Such improved visualization and control may improve quality of the metal substrate 106. In certain embodiments, the output response from the controller 124 may be used to automatically control various equipment associated with the work station 102 to further improve control of the processing and quality of the metal substrate 106.

Referring back to FIG. 1, a method of processing the metal substrate 106 using the metal processing system 100 may include moving the metal substrate 106 in the processing direction 101 and through the harsh environment 104. The method includes detecting the metal substrate 106 in the harsh environment 104 using the one or more cameras 116 and providing visual data using detected infrared radiation. In certain embodiments, the method includes processing the metal substrate 106 using the work station 102, and in one non-limiting example, the method includes rolling the metal substrate 106 using a rolling mill 110 as the work station 102. In some embodiments, detecting the metal substrate 106 in the harsh environment 104 includes using a LWIR camera as the camera 116. Optionally, the method includes generating a control response based on the visual data from the camera 116. In some embodiments, generating the control response includes one or more of providing the visual data to an operator using the user interface 126 and/or other interface, generating an alert or alarm to the operator, and/or controlling equipment of the work station 102 and/or of the metal processing system 100 based on the visual data. Various other processes may be performed using the controller 124, and the aforementioned control process should not be considered limiting.

As mentioned, FIG. 2 illustrates another example of the metal processing system 100 in which the visualization system 114 includes two cameras 116 rather than a single camera 116, and the cameras 116 are offset from edges 120, 122 of the metal substrate 106.

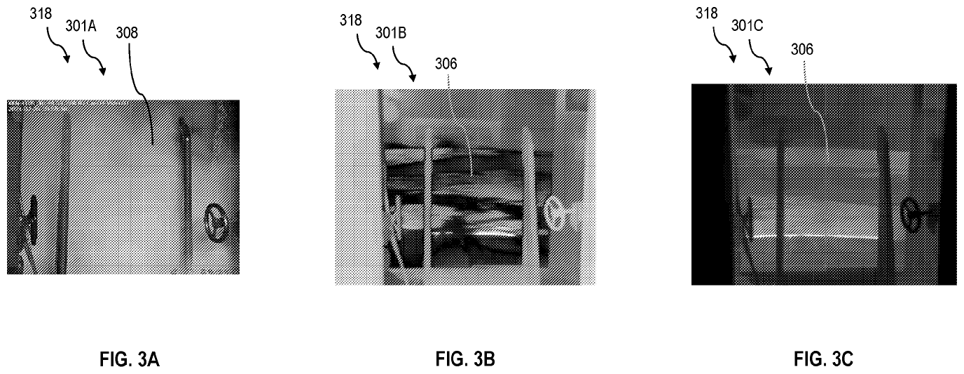

FIGS. 3A-C are photographs of an inter-stand location 318 of a rolling mill 310. FIG. 3A is an image 301A using a visible spectrum camera, FIG. 3B is an image 301B using a first thermal camera according to embodiments of the disclosure, and FIG. 3C is an image 301C using a second thermal camera according to embodiments of the disclosure. As illustrated by comparing FIGS. 3B and 3C to 3A, the images 301B and 301C are able to provide visualization of a metal substrate 306, but in the image 301A the metal substrate is not visible due to the dense fumes 308.

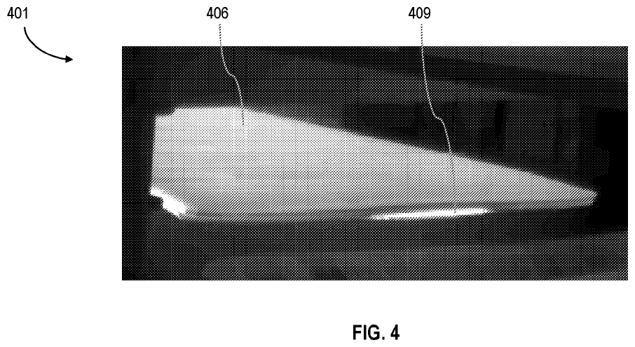

FIG. 4 is an image 401 of a metal substrate 406 from a visualization system according to embodiments. As illustrated in FIG. 4, defects such as but not limited to delamination 409 may be detected and visualized, thereby allowing an operator to control processing of the metal processing system as needed or desired.

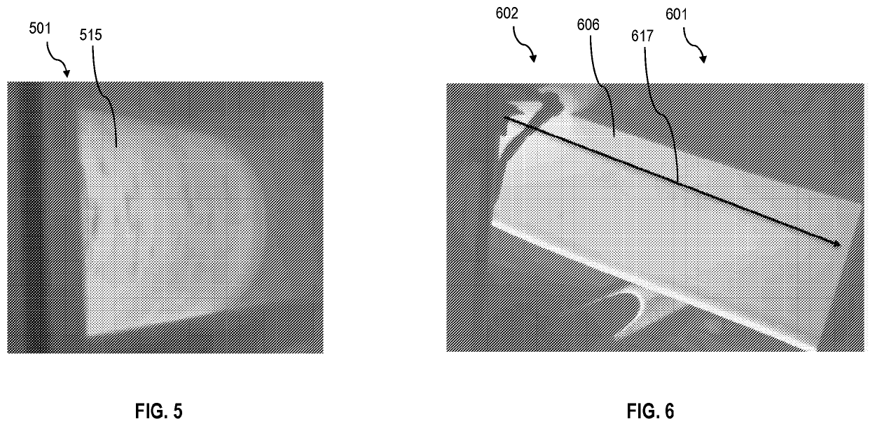

FIG. 5 is an image 501 of a backup roll 515 from a visualization system according to embodiments. As illustrated in FIG. 5, characteristics of the backup roll 515 such as roll thermal camber and cold spots may be detected and visualized, thereby allowing an operator to control processing of the metal processing system as needed or desired.

FIG. 6 is an image 601 of a work station 602 from a visualization system according to embodiments and illustrates a non-limiting example of an output response for the operator that includes a strip gradient measurement 617 of the metal substrate 606.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A metal processing system comprising a vision system for a harsh environment concealing, in a visible spectrum, at least a portion of a metal substrate, the vision system comprising at least one camera configured to detect the metal substrate in the harsh environment and provide visual data of the metal substrate in the harsh environment.

Illustration 2. The metal processing system of any preceding or subsequent illustrations or combination of illustrations, wherein the at least one camera is a thermal camera configured to detect the metal substrate based on infrared radiation of the metal substrate in the harsh environment.

Illustration 3. The metal processing system of any preceding or subsequent illustrations or combination of illustrations, wherein the at least one camera is a long-wave infrared camera.

Illustration 4. The metal processing system of any preceding or subsequent illustrations or combination of illustrations, wherein the at least one camera is a short-wave infrared camera.

Illustration 5. The metal processing system of any preceding or subsequent illustrations or combination of illustrations, further comprising a rolling mill for processing the metal substrate, wherein the rolling mill generates the harsh environment during rolling of the metal substrate.

Illustration 6. The metal processing system of any preceding or subsequent illustrations or combination of illustrations, wherein the at least one camera is a long-wave infrared camera.

Illustration 7. The metal processing system of any preceding or subsequent illustrations or combination of illustrations, wherein the vision system further comprises a controller communicatively coupled with the at least one camera, the controller configured to receive the visual data from the at least one camera and generate a control response based on the visual data.

Illustration 8. The metal processing system of any preceding or subsequent illustrations or combination of illustrations, wherein the controller is configured to control a piece of metal processing equipment of the metal processing system based on the visual data as the control response.

Illustration 9. The metal processing system of any preceding or subsequent illustrations or combination of illustrations, wherein the controller is configured to generate an alert on a user interface as the control response.

Illustration 10. The metal processing system of any preceding or subsequent illustrations or combination of illustrations, wherein the controller is configured to detect at least one characteristic of the metal substrate in the harsh environment and generate the control response based on the detected at least one characteristic.

Illustration 11. A metal processing system comprising: a work station for processing a metal substrate, the work station generating a harsh environment during metal processing, the harsh environment comprising a fume at least partially concealing the metal substrate at the work station; and a vision system comprising at least one camera configured to detect the metal substrate in the harsh environment at the work station and provide visual data of the metal substrate in the harsh environment at the work station.

Illustration 12. The metal processing system of any preceding or subsequent illustrations or combination of illustrations, wherein the work station is a rolling mill.

Illustration 13. The metal processing system of any preceding or subsequent illustrations or combination of illustrations, wherein the at least one camera is configured to detect the metal substrate based on infrared radiation of the metal substrate.

Illustration 14. The metal processing system of any preceding or subsequent illustrations or combination of illustrations, wherein the at least one camera is a long-wave infrared camera.

Illustration 15. The metal processing system of any preceding or subsequent illustrations or combination of illustrations, wherein the at least one camera is a short-wave infrared camera.

Illustration 16. A method of processing a metal substrate with a metal processing system, the method comprising: moving the metal substrate in a harsh environment concealing, in a visible spectrum, at least a portion of the metal substrate; detecting the metal substrate in the harsh environment using at least one camera of a vision system, and providing visual data of the metal substrate in the harsh environment using the at least one camera.

Illustration 17. The method of any preceding or subsequent illustrations or combination of illustrations, wherein moving the metal substrate comprises rolling the metal substrate with a rolling mill of the metal processing system.

Illustration 18. The method of any preceding or subsequent illustrations or combination of illustrations, wherein detecting the metal substrate comprises detecting the metal substrate in an infrared spectrum.

Illustration 19. The method of any preceding or subsequent illustrations or combination of illustrations, wherein the at least one camera is a long-wave infrared camera, and wherein detecting the metal substrate comprises detecting the metal substrate in a long-wave infrared spectrum.

Illustration 20. The method of any preceding or subsequent illustrations or combination of illustrations, further comprising generating a control response based on the visual data by controlling a piece of equipment or generating an alert on a user interface.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. In the figures and the description, like numerals are intended to represent like elements. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

1. A metal processing system comprising a vision system for a harsh environment concealing, in a visible spectrum, at least a portion of a metal substrate, the vision system comprising at least one camera configured to detect the metal substrate in the harsh environment and provide visual data of the metal substrate in the harsh environment.

2. The metal processing system of claim 1, wherein the at least one camera is a thermal camera configured to detect the metal substrate based on infrared radiation of the metal substrate in the harsh environment.

3. The metal processing system of claim 1, wherein the at least one camera is a long-wave infrared camera.

4. The metal processing system of claim 1, wherein the at least one camera is a short-wave infrared camera.

5. The metal processing system of claim 1, further comprising a rolling mill for processing the metal substrate, wherein the rolling mill generates the harsh environment during rolling of the metal substrate.

6. The metal processing system of claim 5, wherein the at least one camera is a long-wave or a short-wave infrared camera.

7. The metal processing system of claim 1, wherein the vision system further comprises a controller communicatively coupled with the at least one camera, the controller configured to receive the visual data from the at least one camera and generate a control response based on the visual data.

8. The metal processing system of claim 7, wherein the controller is configured to control a piece of metal processing equipment of the metal processing system based on the visual data as the control response.

9. The metal processing system of claim 7, wherein the controller is configured to generate an alert on a user interface as the control response.

10. The metal processing system of claim 7, wherein the controller is configured to detect at least one characteristic of the metal substrate in the harsh environment and generate the control response based on the detected at least one characteristic.

11. A metal processing system comprising:
a work station for processing a metal substrate, the work station generating a harsh environment during metal processing, the harsh environment comprising a fume at least partially concealing the metal substrate at the work station; and
a vision system comprising at least one camera configured to detect the metal substrate in the harsh environment at the work station and provide visual data of the metal substrate in the harsh environment at the work station.

12. The metal processing system of claim 11, wherein the work station is a rolling mill.

13. The metal processing system of claim 11, wherein the at least one camera is configured to detect the metal substrate based on infrared radiation of the metal substrate.

14. The metal processing system of claim 13, wherein the at least one camera is a long-wave infrared camera.

15. The metal processing system of claim 13, wherein the at least one camera is a short-wave infrared camera.

16. A method of processing a metal substrate with a metal processing system, the method comprising:
moving the metal substrate in a harsh environment concealing, in a visible spectrum, at least a portion of the metal substrate;
detecting the metal substrate in the harsh environment using at least one camera of a vision system; and
providing visual data of the metal substrate in the harsh environment using the at least one camera.

17. The method of claim 16, wherein moving the metal substrate comprises rolling the metal substrate with a rolling mill of the metal processing system.

18. The method of claim 16, wherein detecting the metal substrate comprises detecting the metal substrate in an infrared spectrum.

19. The method of claim 18, wherein the at least one camera is a long-wave infrared camera, and wherein detecting the metal substrate comprises detecting the metal substrate in a long-wave infrared spectrum.

20. The method of claim 16, further comprising generating a control response based on the visual data by controlling a piece of equipment or generating an alert on a user interface.
